(19) United States
(12) Patent Application Publication
(10) Pub. No.: US 2009/0030931 A1
(43) Pub. Date: Jan. 29, 2009

(54) MULTI-SOURCE MULTI-NETWORK ELECTRONIC SERVICE GUIDE

(76) Inventors: Amit Khivesara, Clifton, NJ (US); Peter Mataga, Sparta, NJ (US); Vinod Valloppillil, San Francisco, CA (US); Edgar Villanueva, Rockaway, NJ (US)

Correspondence Address: Hanify & King Professional Corporation, 1875 K STREET, SUITE 707, WASINGTON, DC, 20006, US

(21) Appl. No.: 12/176,249

(22) Filed: Jul. 18, 2008

Related U.S. Application Data
(60) Provisional application No. 60/935,043, filed on Jul. 24, 2007.

(51) Int. Cl. G06F 17/30

(52) U.S. Cl. 707/102; 707/E17.001

(57) ABSTRACT

A method and system by which a client device can gather ESG data from disparate sources and present them to a user in a unified manner via a single user interface provides improved usability of the ESG. A method for providing an electronic service guide comprises acquiring a plurality of electronic service guides, translating each of the plurality of electronic service guides that was not acquired in a specified representation to the specified representation, combining the plurality of electronic service guides in the specified representation to form a unified electronic service guide, and providing the unified electronic service guide for display.

### CROSS-REFERENCE TO RELATED APPLICATIONS

This application claims the benefit of Provisional Application No. 60/935,043, filed Jul. 24, 2007, the contents of which are incorporated herein in their entirety.

### BACKGROUND OF THE INVENTION

1. Field of the Invention

The present invention relates to a unified electronic service guide (ESG) that is displayed at a client device and is created by combining service data acquired from multiple sources.

2. Description of the Related Art

An Electronic Service Guide User Interface (ESG UI) is an on-screen guide to scheduled or available broadcast content, such as television or radio programs, movies, sports, etc. The ESG UI typically provides functions allowing a user to navigate, select, and display content by time, title, channel, genre, etc. by use of an input device, such as a remote control, a keyboard, a phone keypad, etc. The ESG UI depends on data acquired by the client device; this data will be generically referred to as “ESG” in this description. Especially in the mobile broadcast arena, it may be advantageous for the ESG to describe services available from multiple sources. These sources may include the network operator, a nationwide broadcaster, one or more local broadcasters, one or more broadcast content providers, third party datacast offerings, or content the user directly installs or downloads to their device via a memory card, Bluetooth connection, or personal computer. One entity may not have the rights to aggregate data from all sources in order to provide a single ESG to the user. Under such circumstances, the user may need to browse multiple ESGs in order view all the content that is available.

A need arises for a technique by which a client device can acquire ESG data derived from disparate sources and present that data to a user in a unified manner via a single user interface.

### SUMMARY OF THE INVENTION

A method and system by which a client device can gather ESG data from disparate sources and present them to a user in a unified manner via a single user interface provides improved usability of the ESG. A multi-source ESG service consists of one or both of a server component and a client component. Each component has the ability to take multiple ESGs from various sources, and in various representations, and create a single unified ESG. A representation of ESG data may include a number of physical and logical arrangements of the data. For example, a single representation may include data in more than one format but linked by additional correlation or indexing data, or in intermediate arrangements that are only temporarily stored in memory. In addition, in some cases, the correlation data may refer to information about the content that is embedded in the content itself, e.g. a MP4 file might include information about the file as part of the file, and the correlating data structure provides the filename. The ESG can use such an indirect structure to represent part or all of the ESG data in a representation. The server maintains a number of translation modules, which can translate an ESG from a variety of sources and in a variety of formats into a common ESG representation that is used by the client user interface (UI) to display ESG data to the user. These translation modules can be made available to the client so that conversions can happen locally on the client device. A hybrid mode is also possible in which each client acquires and unifies data from multiple sources, one or more of which is a server that has already performed an intermediate level of unification.

A method for providing an electronic service guide comprises acquiring a plurality of electronic service guides, translating each of the plurality of electronic service guides that was not acquired in a specified format to the specified format or internal representation, combining the plurality of electronic service guides in the specified representation to form a unified electronic service guide, and providing the unified electronic service guide for display. The unification method may involve combining information about different services so that the combined set of services can be displayed in a single guide. The unification method may also involve combining different types of information about the same services so that the unified information can be displayed for each service within the guide.

At least some of the plurality of acquired electronic service guides may be acquired from different sources. The method may be performed in a client device. The client device may be a wireless device. The providing step may comprise the steps of providing the unified electronic service guide to a browser application on the client device, and displaying the unified electronic service guide using the browser application. At least one of plurality of electronic service guides may be acquired from a server, and at least one of plurality of electronic service guides is acquired from another source.

The method may further comprise the step of filtering the acquired electronic service guides so as to include in the unified electronic service guide only information relating to services to which a user of the client device has subscribed. The method may further comprise the step of filtering the acquired electronic service guides so as to include in the unified electronic service guide only information relating to services which are relevant to the user or are available at a current location of the client device. At least one of the electronic service guides may be acquired from a memory device connected to the client device.

The method may be performed in a server. The providing step may comprise the steps of delivering the unified electronic service guide to a client device. Delivery may include transmitting the unified electronic service guide over a broadcast or multicast network to a client device, or of providing the unified ESG to each client via a request-response protocol such as HTTP. In the request-response case, the method may further comprise the step of filtering the delivered electronic service guide so as to include in the unified electronic service guide only information relating to services which are relevant to the user or are available at a current location of the client device.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of a system in which the present invention may be implemented.

FIG. 2 is an exemplary flow diagram of a process of ESG translation and combination that may be performed in the system shown in FIG. 1

FIG. 3 is an exemplary diagram illustrating processing of types of content that may provide ESG data.

FIG. 4 is an exemplary diagram illustrating translating and combining ESG data from multiple sources.

FIG. 5 is an exemplary block diagram of server computer system, in which the present invention may be implemented.

FIG. 6 is an exemplary block diagram of client device, in which the present invention may be implemented.

### DETAILED DESCRIPTION OF THE INVENTION

The multi-source ESG service consists of one or both of a server component and a client component. Each component has the ability to take multiple ESGs from various sources, and in various representations, and create a single unified ESG. The server maintains a number of translation modules, which can translate an ESG from a variety of sources and in a variety of formats into a common ESG representation that is used by the client UI to display ESG data to the user. These translation modules can be made available to the client so that conversions can happen locally on the client device.

An electronic service guide (ESG) refers to the data and application used to present such data to the user that contains a listing of services, programs, or other content that the user can access. The data includes not only programming information such as time, title, and details, but how the application tunes in to or otherwise accesses the content. The content need not be time based, such as a video on demand channel. Traditional ESGs provide the user details on programs, services, and other content available from a single provider. A unified ESG combines ESG data from multiple providers and presents the combined data using a single application to the user.

A datacast application is a broadcast application that generally does not involve streaming media such as audio or video. Instead, data describing the content is broadcast, and rendered to the user via a specialized application on the client device. For example, a play-by-play baseball application would use data describing the events in the baseball game to display what is happening to the user. The data would include all pertinent aspects of the game, including play-by-play results. The bandwidth required by a datacast application is typically much smaller than that needed by a content streaming application.

Side-loaded content refers to content that is directly loaded onto the device via means such as memory cards, Bluetooth connections, or downloaded from a personal computer via a USB cable or other means.

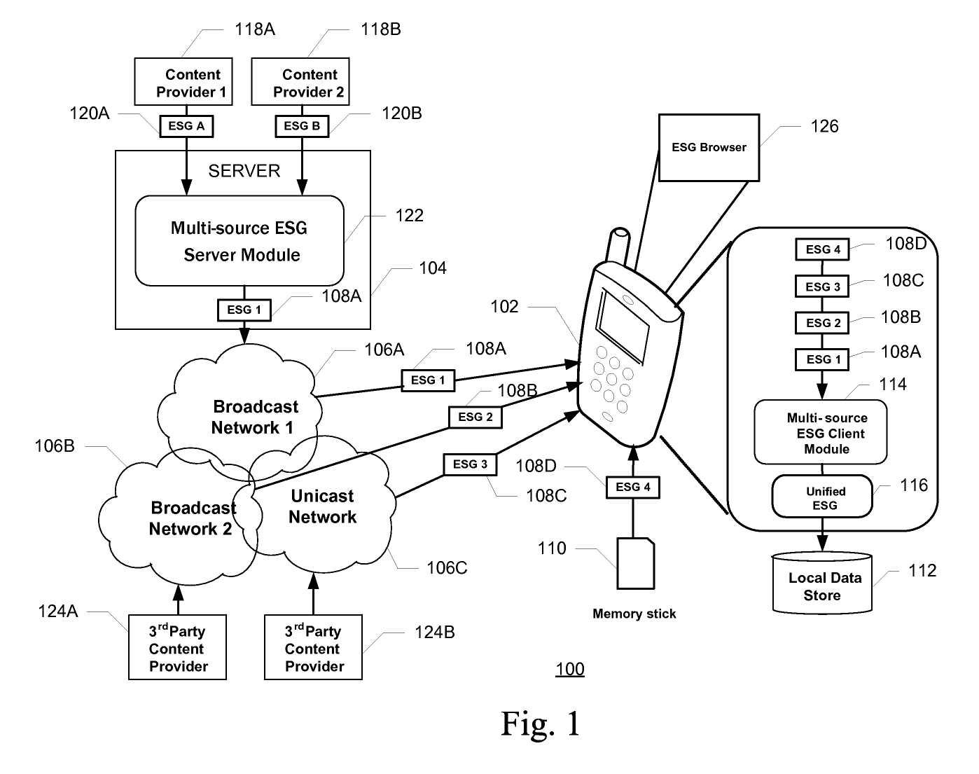

A system 100 in which the present invention may be implemented is shown in FIG. 1. System 100 includes client device 102, server 104, and a plurality of broadcast and/or unicast networks 106A-C. Client device 102 is any device that is capable of acquiring, playing or displaying broadcast or unicast content. Examples of such devices include, but are not limited to, mobile phones, mp3 or other media players, cameras, PDAs, personal computers, etc. Client device 102 is provided with a plurality of ESGs, such as ESGs 1-3 108A-C acquired from broadcast/unicast networks 106A-C, and ESG 4 108D, acquired from a media or memory device, such as memory stick 110. Client device 102 includes a local data store 112, which it uses to store, among other data, the acquired ESGs 108A-D. Client device 102 also includes Multi-source ESG Client Module (client component) 114, which is software that acquires the separate ESGs 108A-D and processes the separate ESGs 108A-D to form Unified ESG 116. Unified ESG 116 is then stored in local data store 112.

Client component 114 provides the following features, among others:

Combines ESG data from multiple sources into a single, unified ESG

Obtains ESG translation modules from the server when encountering an ESG format that is not known to the client

Obtains ESG data for side-loaded content that did not come with its own ESG data

Filters ESG data based on current geographic location.

ESG data acquired by the client can come from the primary network servicing the client, other networks the client has the ability to acquire services from, or external sources directly loaded onto the client device by the user such as memory cards, direct download from a personal computer, or wireless transfers from other devices.

Client device 102 also includes ESG browser software 126, such as a plug-in, applet, or application, that provides the capability to display ESG information to a user of the client device 102, and to accept commands allowing a user to navigate, select, and display content by parameters, such as time, title, channel, genre, etc., by use of an input device, such as a remote control, a keyboard, a phone keypad, etc.

Server 104 is connected to a plurality of content providers, such as content providers 118A-B. Each content provider provides an ESG relating to its content, such as ESGs A and B 120A-B, to server 104. Server 104 includes Multi-source ESG Server Module (server component) 122, which is software that acquires the separate ESGs 120A-B and processes the separate ESGs 120A-B to form ESG 108A. ESG 108A is then provided to broadcast network 106A for delivery to client devices, such as client device 102. As may be seen from FIG. 1, an ESG that may be considered a separate ESG at some point in system 100 may be considered a unified ESG at other points in system 100. For example, ESG 108A is considered to be a separate ESG by client device 102, even though it was formed by the unification of a plurality of ESGs 118A-B, and is considered a unified ESG by server 104.

Server component 122 provides the following features, among others:

Combines ESG data from multiple sources into a single, unified ESG

Distributes the unified ESG to devices on the server's network

Maintains ESG translation modules, and distributes such modules as needed to devices on the server's network

Provides ESG data for known side-loadable content

Other broadcast/unicast networks, such as broadcast/unicast networks 106B and 106C, are also connected to content providers, such as 3^{rd} Party Content Providers 124A-B. Content Providers, such as 124A-B, may provide ESGs to broadcast/unicast networks, such as 106B and 106C, either directly, or through servers similar to server 104.

The multi-source ESG service aggregates ESG data from multiple, disparate sources at one or both of the server and the client, and creates a single ESG that can be displayed on user devices allowing them to browse all content that is available for consumption within a single application user-interface. This is accomplished by translating, or converting, any arbitrary ESG data into a standard ESG data representation that is recognized by the ESG browsing application. The translation or conversion process may also modify, add, or delete ESG data based on the access rights of the user of the device on which the ESG will be displayed, or of other attributes of the display device such as its location.

Server Component

The server 104, when present, will typically be located in the network of the primary service provider. For example, in FIG. 1, the primary service provider may operate broadcast network 1 106A. The primary service provider may aggregate ESG data from multiple sources of content. These sources of content may come from sources such as nationwide broadcaster providers, one or more local broadcast providers, unicast providers, or any other mean by which content can be made available to a client device 102, such as side-loaded content obtained from memory cards 110 or downloaded to the device via a personal computer. After aggregating ESG data from multiple sources, the server component will make the unified ESG data 108A available to client devices, such as 102, being serviced by the service provider. This can be accomplished by broadcasting the ESG data over a known channel at known times, or making the ESG data available upon request by a particular client, or a combination of those or other methods.

When a client component 114 is present, the server component 122 may also provide translation instructions, methods, or services to client devices 102 that are translating or combining ESG data from multiple sources. In circumstances where the client device 102 may not know how to translate or convert the ESG data from a particular source into the common representation used by the ESG browsing application, the client device 102 may contact the server 104 for instructions or methods, or give the server 104 the ESG data in question and ask for the server 104 to perform the conversion or translation.

Client Component

The client component 114, when present, can acquire ESG data from multiple sources, including from the primary service provider, local broadcast providers, third party services that may broadcast their ESG data over a known channel, unicast providers where ESG data can be obtained directly from the content provider, or side-loaded content directly downloaded onto the device via a memory card or personal computer connection. As the user roams from a region served by Local Broadcaster A to a region served by Local Broadcaster B, the client component will discard ESG fragments that describe Local broadcaster A and replace it with fragments from the new broadcaster.

ESG data obtained or acquired by the client may need to be converted or translated into a representation that can be used by the ESG browser application 126. The converted or translated data will then be provided to the ESG browser application 126 either in the form of a single, unified ESG, or a number of files or other data elements that the ESG browser application 126 has access to.

In order to perform the ESG data translation or conversion, the client needs to understand both the format of the ESG being converted, and the representation of the ESG data that the ESG browser application 126 expects. The ESG format may be described in the data itself (e.g., a particular XML schema) or may be inferred from the delivery mechanism of the data (e.g., a standard protocol for ESG delivery). The client device 102 can be pre-loaded with information regarding all necessary ESG formats, though it is likely that new formats will be encountered. To support new formats, the client device 102 can obtain the necessary information from the server component 122. Any of a variety of distribution methods can be used. The server 104 can broadcast new ESG data format information on a known channel, the client device 102 can initiate a transaction with the server 104 to obtain the ESG format information, or the client device 102 can request that the server component 122 perform the translation and return the ESG data in the representation needed for the ESG browser application 126. For side-loaded content, the ESG data format description may come with the ESG itself, or require one of the aforementioned methods.

Side-loaded content may not necessarily come with associated ESG data. In such cases, the client device may need to obtain that information from the server module or from a third party content provider by listening to a broadcast channel or asking directly.

ESG Data Translation

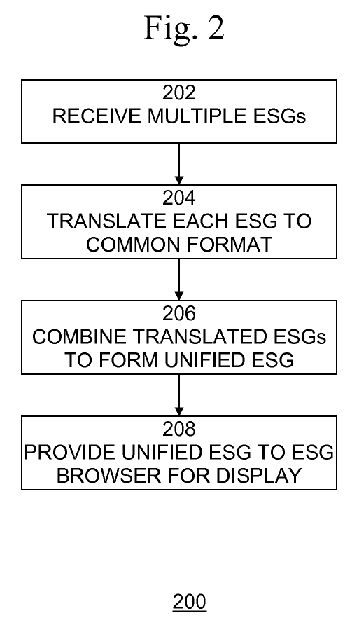

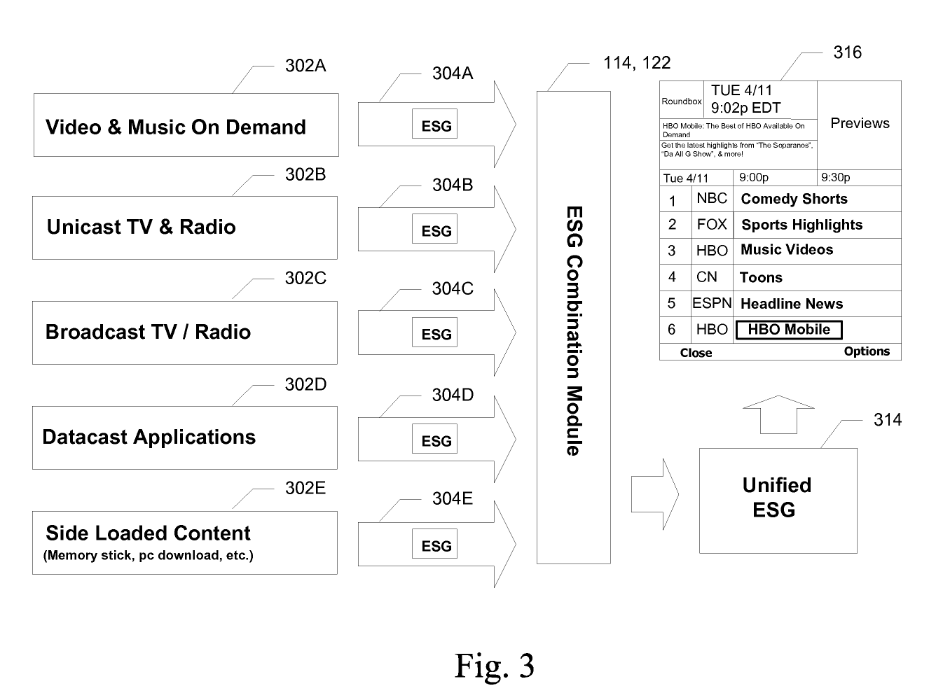

An example of a process 200 of ESG translation and combination to form a unified ESG is shown in FIG. 2. It is best viewed in conjunction with FIG. 3, which is an exemplary diagram illustrating processing of types of content that may provide ESG data, and with FIG. 1. In step 202 of FIG. 2, process 200 acquires data comprising multiple ESGs. The ESG data describes different kinds of content available to the user. As shown in FIG. 3, some examples of types of content are video & music on demand 302A, unicast cast TV & radio 302B, broadcast TV & radio 302C, datacast applications 302D, side loaded content 302E, etc. Each source of content may provide one or more ESGs 304A-E. Each type of content needs different fields to describe it in an ESG. These fields will need to be converted or translated into a representation that the ESG browser application 126 requires. In step 204, each ESG is translated to a common representation. In this step, ESG Combination Module 114 or 122 performs, provides or obtains the appropriate translations for each ESG. In step 206, the translated ESGs are combined to form a unified ESG 314. ESG 314 is then used by ESG browser application 126 to display 316 ESG information to a user of client device 102.

The ESG browser application 126 dictates the representation the ESG data must be stored in so that the unified ESG 314 data can be displayed 316 to the user and the content the user selects can be accessed. All ESG data must be converted into the representation used by ESG browser application 126. The server module 122 located in the service provider's network will send ESG data to the client device 102 in the correct format. However, other ESG data providers may have their own ESG format which will need to be converted or translated into a representation which the ESG browser application 126 requires. The conversion can be as simple as mapping fields from one format to another, or more complex and include the merging and/or parsing fields.

Fields that may be used by the ESG browser application 126 may include, but are not limited to:

Short program name or content title for display in the grid

Channel, or group to which the program or content belongs

Day and time information for when the program or content will be available

Duration of the program or content

Short content description

Long content description

Program or content access rights

Content type, what application is needed to view, listen to, or otherwise use content

URI, file, or other pointer where the program or content can be obtained

For each channel, or content grouping, additional fields may identify the channel or group as a whole:

Channel number or name

Channel image or logo

Short description

Long description

URI, file, or other pointer or method on how to access programs or other content available on this channel or in this group

There may be cases where channel numbers or group names conflict in different ESG data sets. The conversion or translation methods used on such ESG data may include details as how to deal with name and channel conflicts, such as renaming or merging rules. Merging rules could cover cases where specific programs or content conflict for the same channel or group (e.g., two programs available on the same channel at the same time).

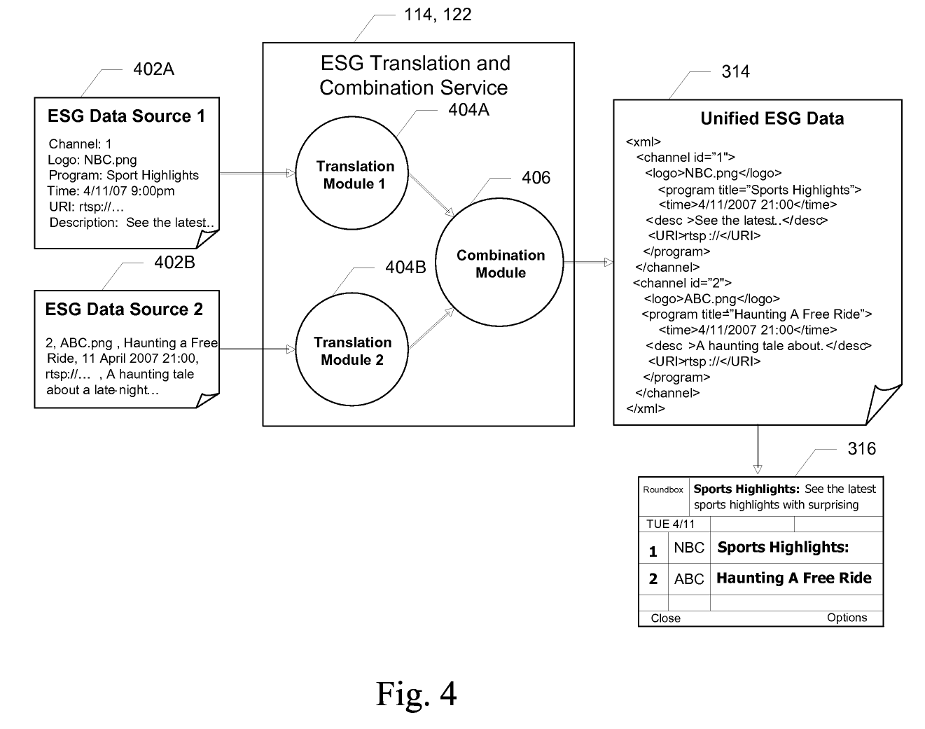

Referring briefly to FIG. 4, an example shows two ESG data sources 402A-B with different ESG data formats. One format, of ESG data source 402A, is represented by description/value pairs, while the format, of ESG data source 402B, is represented as a comma separated file. Within ESG translation and combination module 114, 122, a translation module 404A-B associated with each ESG data format translates the data associated with each ESG into the standard, or unified, representation, shown in this example as an XML file. A combination module 406 merges the two (or more) sets of ESG data to form Unified ESG Data 314. The ESG browser application 126 then uses the combined ESG data to display content information to the user of the device.

ESG Browser Application Integration

It may be the case where the client ESG browser application contains all the functionality described for the client component above. In other words, the translation from multiple ESG data sources with different formats may be performed in real-time by the ESG browser application. In such cases multiple ESG data files may be stored in a common location for the ESG browser application to read.

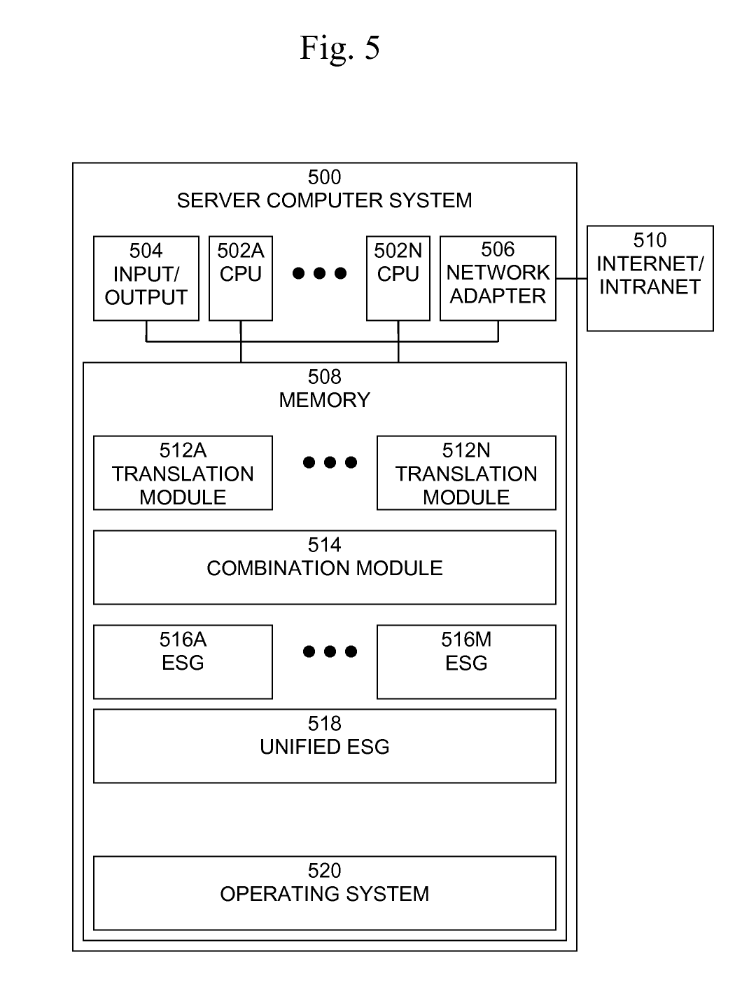

An exemplary block diagram of a server computer system 500, such as a content server or a device management server, shown in FIG. 2, is shown in FIG. 5. Server 500 is typically a programmed general-purpose computer system, such as a personal computer, workstation, server system, and minicomputer or mainframe computer. Server 500 includes one or more processors (CPUs) 502A-502N, input/output circuitry 504, network adapter 506, and memory 508. CPUs 502A-502N execute program instructions in order to carry out the functions of the present invention. Typically, CPUs 502A-502N are one or more microprocessors, such as an INTEL PENTIUM® processor. FIG. 5 illustrates an embodiment in which Server 500 is implemented as a single multi-processor computer system, in which multiple processors 502A-502N share system resources, such as memory 508, input/output circuitry 504, and network adapter 506. However, the present invention also contemplates embodiments in which server 500 is implemented as a plurality of networked computer systems, which may be single-processor computer systems, multi-processor computer systems, or a mix thereof.

Input/output circuitry 504 provides the capability to input data to, or output data from, database/server 500. For example, input/output circuitry may include input devices, such as keyboards, mice, touchpads, trackballs, scanners, etc., output devices, such as video adapters, monitors, printers, etc., and input/output devices, such as, modems, etc. Bearer network adapter 506 interfaces device 500 with a plurality of bearer networks 510A-N. Bearer networks 510A-N may be any standard point-to-point bearer network or WLAN, such as GSM, GPRS, EV-DO, WiMAX, LTE, WiFi, CDMA, etc., a broadcast or multicast bearer network such as MediaFLO™, DVB-H, DMB, WiMAX MBS, MBMS, BCMCS, etc., or a private or proprietary bearer network.

Memory 508 stores program instructions that are executed by, and data that are used and processed by, CPU 502 to perform the functions of server 500. Memory 508 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 508 varies depending upon the function that server 500 is programmed to perform. In the example shown in FIG. 5, memory 508 includes translation modules 512A-N, combination module 514, ESGs 516A-M, unified ESG 518, and operating system 520. Translation modules 512A-N include software associated with each ESG data format that translates the data associated with each ESGs 516A-M into a standard, or unified, representation. Combination module 514 include software merges two or more sets of ESG data 516A-M to form Unified ESG 518. Operating system 520 provides overall system functionality.

As shown in FIG. 5, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®G, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

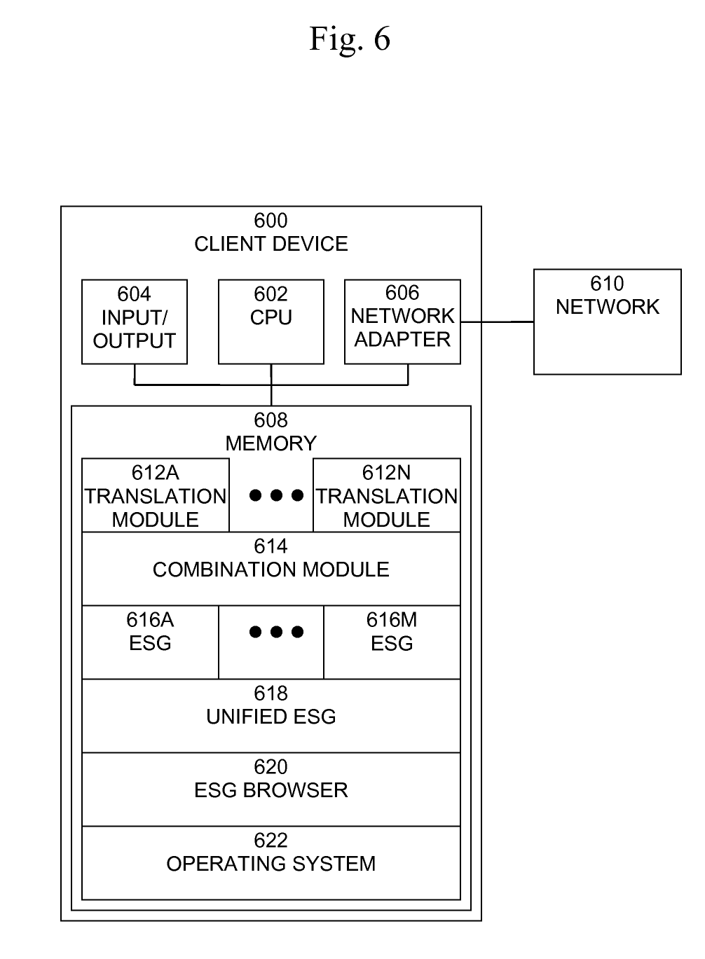

An exemplary block diagram of a client device 600 in which the present invention may be implemented is shown in FIG. 6. Device 600 is typically a mobile communication and/or computation device. Mobile devices include but are not limited to mobile phones, personal digital assistants, in-vehicle receivers and multimedia systems, laptops and other portable computing devices, any of which may acquire ESG data and content via wireless point-to-point or unidirectional (broadcast/multicast) networks. Device 600 includes processor (CPU) 602, input/output circuitry 604, network adapter 606, memory 608, and mass storage 610. CPU 602 executes program instructions in order to carry out the functions of the present invention. Typically, CPU 602 is an embedded microprocessor, but may also be a microcomputer or other embedded processing device. Although in the example shown in FIG. 6, device 600 is a single processor system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which device 600 is implemented on a plurality of networked computer systems, which may be single-processor computer systems, multi-processor computer systems, or a mix thereof.

Input/output circuitry 604 provides the capability to input data to, or output data from, device 600. For example, input/output circuitry may include input devices, such as keyboards, mice, touchpads, trackballs, scanners, etc., output devices, such as video adapters, monitors, printers, etc., and input/output devices, such as, modems, etc. Bearer network adapter 606 interfaces device 600 with a plurality of bearer networks 611A-N. Bearer networks 611A-N may be any standard point-to-point bearer network or WLAN, such as GSM, GPRS, EV-DO, WiMAX, LTE, WiFi, CDMA, etc., a broadcast or multicast bearer network such as MediaFLO™, DVB-H, DMB, WiMAX MBS, MBMS, BCMCS, etc., or a private or proprietary bearer network.

Memory 608 stores program instructions that are executed by, and data that are used and processed by, CPU 602 to perform the functions of the present invention. Memory 608 may include volatile memory, including electronic memory devices such as random-access memory (RAM), and non-volatile memory, including electronic memory devices such as read-only memory (ROM), programmable read-only memory (PROM), electrically erasable programmable read-only memory (EEPROM), flash memory, etc. Memory 608 may also include mass storage that provides the capability to store large amounts of information, such as program instructions and data, in a persistent and accessible form. Mass storage typically includes electromechanical storage devices, such as magnetic disk drives, tape drives, optical disk drives, etc., which may use an integrated drive electronics (IDE) interface, or a variation or enhancement thereof, such as enhanced IDE (EIDE) ultra direct memory access (UDMA), or Serial Advanced Technology Attachment (SATA), or a small computer system interface (SCSI) based interface, or a variation or enhancement thereof, such as fast-SCSI, wide-SCSI, fast and wide-SCSI, etc, or a fiber channel-arbitrated loop (FC-AL), etc. Mass storage may also include electronic memory devices, which are typically non-volatile devices, such as those described above, but which also may be volatile memory devices or may be removable from the server or client device.

Memory 608 includes translation modules 612A-N, combination module 614, ESGs 616A-M, unified ESG 618, ESG browser 620, and operating system 622. Translation modules 612A-N include software associated with each ESG data format that translates the data associated with each ESGs 616A-M into a standard, or unified, representation. Combination module 614 includes software that merges two or more sets of ESG data 616A-M to form Unified ESG 618. ESG browser 620 includes software such as a plug-in, applet, or application, that provides the capability to display ESG information to a user of the client device 102, and to accept commands allowing a user to navigate, select, and display content by parameters, such as time, title, channel, genre, etc., by use of an input device, such as a remote control, a keyboard, a phone keypad, etc. Operating system 622 provides overall system functionality.

Additional features and functions provided by the present invention include:

The server may combine ESG data from several sources for delivery to all clients. A source may be, for example, a remote ESG server, a local or remote database or metadata associated with content visible to the unifying server.

The client combines ESG data from multiple sources (primary server+others) and creates unified ESG data such that one ESG rendering application can present a single experience to the user containing all programming information, regardless of source. A source may be, for example, a remote ESG server (including a unifying server as in this invention), a locally stored ESG, or metadata associated with content visible to the unifying client, such as side-loaded content.

The client or server ESG may filter ESG data and only include services for which the user is subscribed to, or which matches other client-specific attributes such as location.

The client may contact a service provider to obtain ESG data for side-loaded content, if such data is not provided when the content is loaded on to the device.

As a user roams from one region described by Local Broadcaster A to Local Broadcaster B, the client ESG may filter and discard ESG fragments that describe Local Broadcaster A and replace it with fragments from the new broadcaster.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include storage media, examples of which include, but are not limited to, floppy disks, hard disk drives, CD-ROMs, DVDROMs, RAM, and, flash memory, as well as transmission media, examples of which include, but are not limited to, digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for providing an electronic service guide comprising:
acquiring a plurality of electronic service guides from one or more sources,
translating each of the plurality of electronic service guides that was not acquired in a specified representation to the specified representation;
combining the plurality of electronic service guides in the specified representation to form a unified electronic service guide;
filtering the unified electronic service guide based on location, attributes of a user or attributes of a client device for which the electronic service guide is to be used; and
providing the unified electronic service guide for display or further processing.

2. The method of claim 1, wherein the method is performed in a client device.

3. The method of claim 2, wherein the client device is a mobile device.

4. The method of claim 2, wherein the providing step comprises the steps of:
providing the unified electronic service guide to a browser application on the client device, and
displaying the unified electronic service guide using the browser application.

5. The method of claim 2, wherein at least one of the electronic service guides is acquired from a memory device connected to the client device.

6. The method of claim 1, wherein the method is performed in a server.

7. The method of claim 6, wherein the providing step comprises the steps of:
delivering the unified electronic service guide to a client device.

8. The method of claim 1, wherein the plurality of electronic service guides comprise information relating to different services, different types of information about the same services, or both, and the combining step comprises:
combining the information relating to different services, different types of information about the same services, or both, to form a unified electronic service guide.

9. A client device for displaying an electronic service guide to a user, the client device comprising:
a processor to execute computer program instructions;
a display to display information to a user;
a memory to store computer program instructions executable by the processor; and
computer program instructions stored in the memory and executable to perform the steps of:
acquiring a plurality of electronic service guides from one or more sources,
translating each of the plurality of electronic service guides that was not acquired in a specified representation to the specified representation;
combining the plurality of electronic service guides in the specified representation to form a unified electronic service guide,
filtering the unified electronic service guide based on location, attributes of the user or attributes of the client device for which the electronic service guide is to be used, and
displaying the unified electronic service guide on the display.

10. The device of claim 9, wherein the client device is a mobile device.

11. The device of claim 9, wherein the displaying step comprises:
providing the unified electronic service guide to a browser application on the client device, and
displaying the unified electronic service guide using the browser application.

12. The device of claim 9, wherein at least one of plurality of electronic service guides is acquired from a server, and at least one of plurality of electronic service guides is acquired from another source.

13. The device of claim 9, wherein at least one of the electronic service guides is acquired from a memory device connected to the client device.

14. The device of claim 9, wherein the plurality of electronic service guides comprise information relating to different services, different types of information about the same services, or both, and the combining step comprises:
combining the information relating to different services, different types of information about the same services, or both, to form a unified electronic service guide.

15. A server for providing an electronic service guide to a client device, the server comprising:
a processor to execute computer program instructions;
a memory to store computer program instructions executable by the processor; and
computer program instructions stored in the memory and executable to perform the steps of:
acquiring a plurality of electronic service guides from one or more sources,
translating each of the plurality of electronic service guides that was not acquired in a specified representation to the specified representation;
combining the plurality of electronic service guides in the specified representation to form a unified electronic service guide,
filtering the unified electronic service guide based on attributes of a user or a client device for which the electronic service guide is to be used, and
delivering the unified electronic service guide to the client device.

16. The server of claim 15, wherein the client device is a mobile device.

17. The server of claim 15, wherein the client device displays the delivered guide or performs unification with other sources prior to display.

18. The device of claim 15, wherein the plurality of electronic service guides comprise information relating to different services, different types of information about the same services, or both, and the combining step comprises:
combining the information relating to different services, different types of information about the same services, or both, to form a unified electronic service guide.

19. A computer program product for providing an electronic service guide, comprising:
a computer readable storage medium;
computer program instructions, recorded on the computer readable medium, executable by a processor, for performing the steps of;
acquiring a plurality of electronic service guides from one or more sources,
translating each of the plurality of electronic service guides that was not acquired in a specified representation to the specified representation;
combining the plurality of electronic service guides in the specified representation to form a unified electronic service guide,
filtering the unified electronic service guide based on attributes of a user or attributes of a client device for which the electronic service guide is to be used, and
providing the unified electronic service guide for display or further processing.

20. The computer program product of claim 19, wherein the computer program instructions are executed in a client device.

21. The computer program product of claim 20, wherein the client device is a mobile device.

22. The computer program product of claim 20, wherein the providing step comprises the steps of:
providing the unified electronic service guide to a browser application on the client device, and
displaying the unified electronic service guide using the browser application.

23. The computer program product of claim 20, wherein at least one of the electronic service guides is acquired from a memory device connected to the client device.

24. The computer program product of claim 19, wherein the computer program instructions are executed in a server.

25. The computer program product of claim 24, wherein the providing step comprises the steps of:
delivering the unified electronic service guide to a client device, which displays the delivered guide or performs unification with other sources prior to display.

26. The computer program product of claim 19, wherein the plurality of electronic service guides comprise information relating to different services, different types of information about the same services, or both, and the combining step comprises:
combining the information relating to different services, different types of information about the same services, or both, to form a unified electronic service guide.
